(19) United States
(12) Patent Application Publication
(10) Pub. No.: US 2007/0141438 A1
(43) Pub. Date: Jun. 21, 2007

(54) Fuel cell stack

(76) Inventors: Robert L. Hamm, Saratoga Springs, NY (US); Gregory C. Pacifico, Latham, NY (US)

Correspondence Address: TROP PRUNER & HU, PC, 1616 S. VOSS ROAD, SUITE 750, HOUSTON, TX, 77057-2631, US

(21) Appl. No.: 11/312,938

(22) Filed: Dec. 20, 2005

(51) Int. Cl. H01M 8/02

(52) U.S. Cl. 429/38; 429/37; 429/13

(57) ABSTRACT

A flow plate for a fuel cell includes an active area to communicate a reactant flow to a membrane electrode assembly. The flow plate also includes a recessed region that is substantially the same size as the active area and receives the membrane electrode assembly.

### BACKGROUND

The invention generally relates to a fuel cell stack.

A fuel cell is an electrochemical device that converts chemical energy directly into electrical energy. For example, one type of fuel cell includes a proton exchange membrane (PEM), which permits only protons to pass between an anode and a cathode of the fuel cell. Typically PEM fuel cells employ sulfonic-acid-based ionomers, such as Nafion, and operate in the 60° Celsius (C) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, a flow plate for a fuel cell includes an active area to communicate a reactant flow to a membrane electrode assembly. The flow plate includes a recessed region that is substantially the same size as the active area to form at least part of a pocket to receive the membrane electrode assembly.

In another embodiment of the invention, a fuel cell stack includes a first flow plate, a second flow plate, an active region and a pocket. The active region is located between the first and second flow plates to communicate reactant flows to a fuel cell. The pocket is formed in the active region to receive a membrane electrode assembly of the fuel cell.

In yet another embodiment of the invention, a fuel cell stack includes end plates, flow plates and a stop. The flow plates are located between the end plates, and the stop is located between the end plates to limit a compressive force that is exerted on the flow plates.

Advantages and other features of the invention will become apparent from the following drawing, description and claims.

### BRIEF DESCRIPTION OF THE DRAWING

FIG. 1 is a top perspective view of a cathode cooler flow plate.

FIG. 2 is a bottom perspective view of the flow plate.

FIG. 3 is an illustration of the organization of a fuel cell stack according to an embodiment of the invention.

FIGS. 4, 5, 6, 7 and 8 depict different arrangements to form a membrane electrode assembly pocket according to different embodiments of the invention.

FIG. 9 is a schematic diagram of a fuel cell stack according to an embodiment of the invention.

### DETAILED DESCRIPTION

A fuel cell stack includes elastomeric gaskets that are located between flow plates of the stack for purposes of isolating the fuel, oxidant and coolant flows. An overall compressive force is applied to the fuel cell stack to compress the gaskets so that the gaskets form the needed fluid seals. Conventionally, this means that a relatively constant compressive force is applied to the membrane electrode assemblies (MEAs) of the stack, which places each MEA in a creep mode. In this creep mode, some MEAs, particularly those that are thicker, may rapidly thin and puncture if enough force is applied.

In contrast to conventional fuel cell stacks, a fuel cell stack in accordance with an embodiment of the invention has features, which prevent excessive forces on its MEAs, thereby avoiding the MEA creep mode. As a result, the reliability and lifetimes of the MEAs are increased, as compared to conventional fuel cell stack designs. Additionally, as further described below, these features limit the interfacial resistances of the MEAs.

More specifically, in accordance with embodiments of the invention that are described herein, recessed regions called “pockets” are formed in the fuel cell stack to receive the MEAs for purposes of precisely controlling the strain on each MEA. Each MEA pocket may be formed by a recessed region in a flow plate, may be formed by recessed regions in adjacent flow plates or may be formed using a shim between two adjacent flow plates. The MEA pocket, combined with an associated hardstop region between the flow plates, regulates the strain that is applied to the MEA and causes stress relaxation rather than creep to take place. Additionally, as further described below, due to the precise control of the force that is applied to the MEA, a mechanism is established to hydraulically force phosphoric acid from the membrane, which, in turn, reduces the interfacial resistance of the MEA.

The fuel cell stacks that are disclosed herein may use high temperature (140 C to 200 C, for example) PBI-H₃PO₄ MEAs. However, other types of MEAs may be used in other embodiments of the invention.

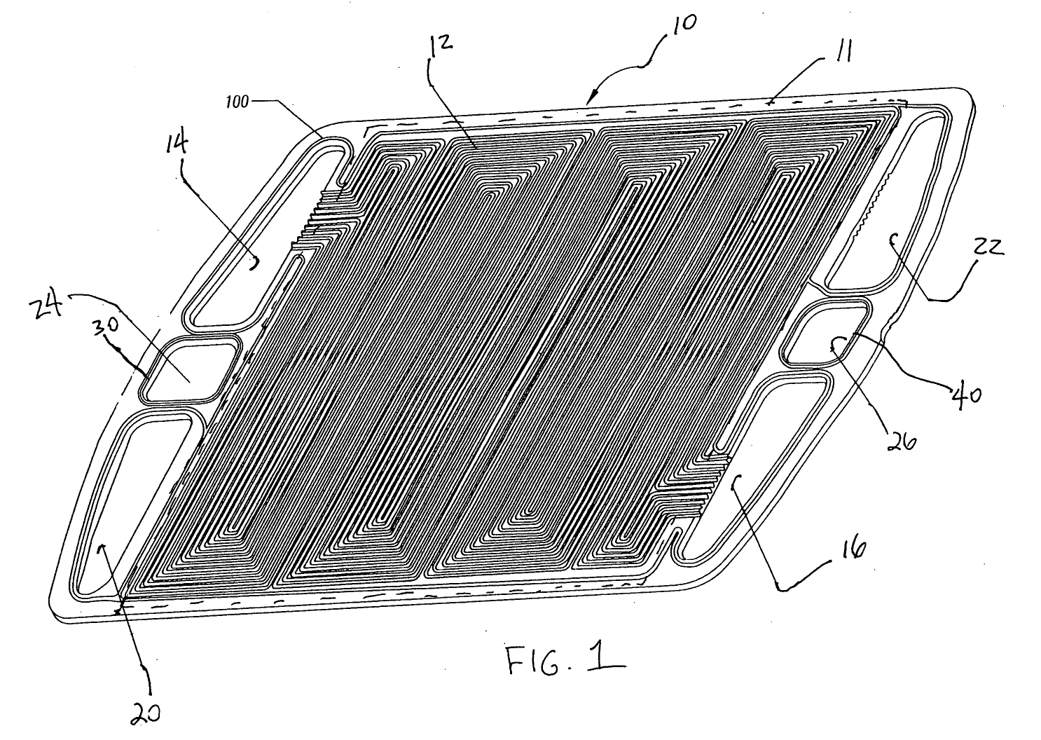

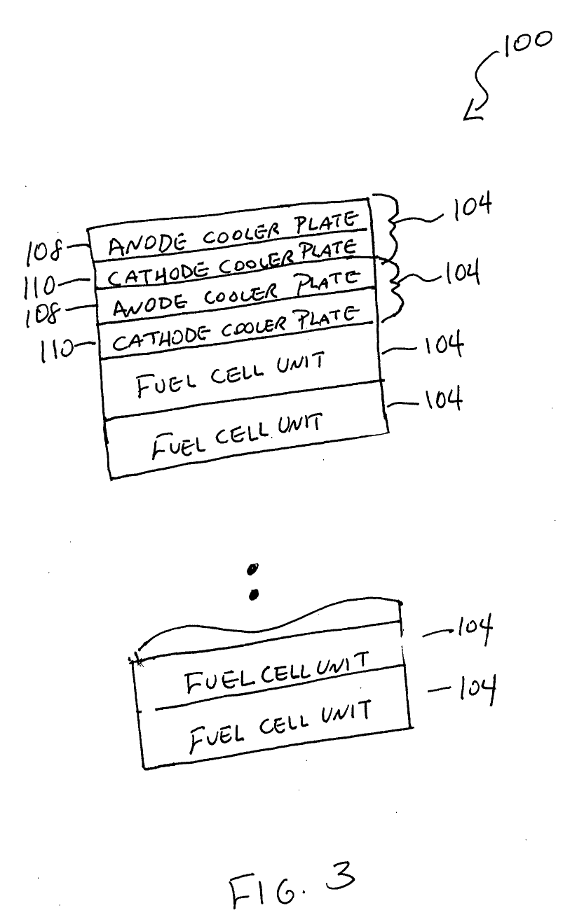

As an introduction to fuel cell flow plates, FIG. 1 depicts an exemplary cathode cooler flow plate 10, which does not have an MEA pocket. FIGS. 4-8, discussed below, illustrate different ways to form the MEA pocket.

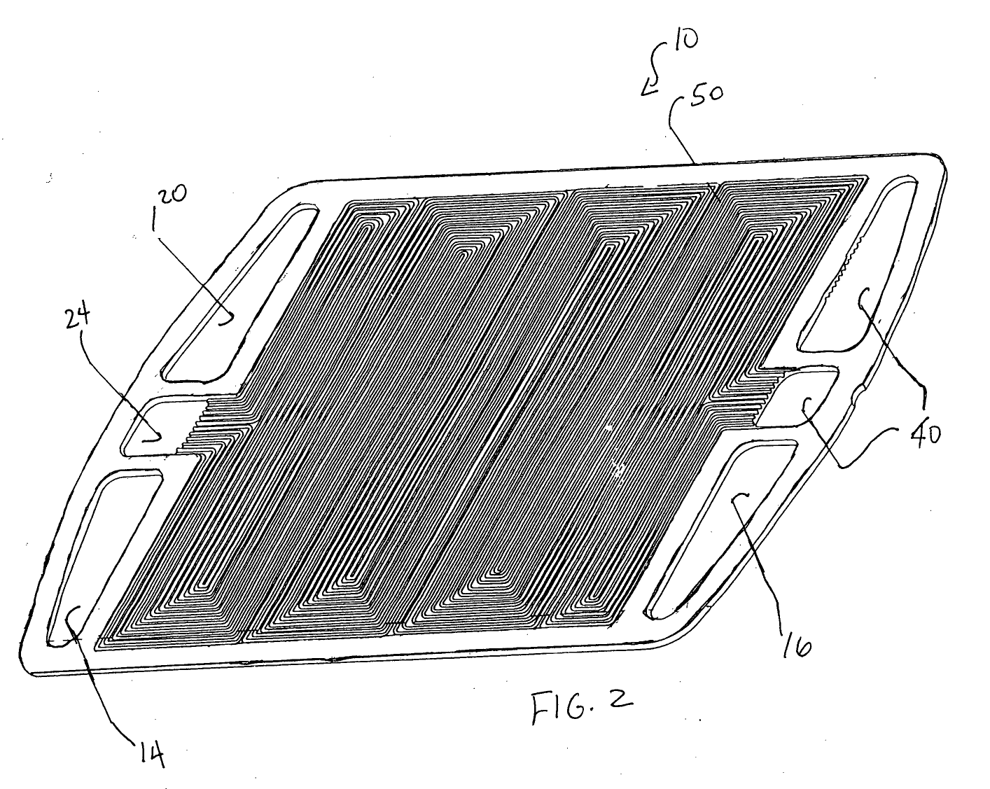

Turning now to the exemplary cathode cooler flow plate 10, plate 10 has a top surface (FIG. 1) that is associated with the cathode of a particular fuel cell and communicates an oxidant flow; and the plate 10 has a bottom surface (FIG. 2) that communicates coolant. Referring to FIG. 1, the cathode cooler flow plate 10 includes an active area 11 that has serpentine flow channels 12 to communicate the oxidant to an MEA (not shown) that resides next to the active area 11.

The oxidant flows through the flow channels 12 from the inlet plenum of the fuel cell stack to the stack's outlet plenum. The inlet and outlet plenums are formed from openings of the stack's fuel cell plates. For example, FIG. 1 depicts openings 14, 20 and 24 that may form part of the inlet plenum of the fuel cell stack. As a more specific example, the opening 14 may form part of the oxidant passageway of the inlet plenum, the opening 20 may form part of the fuel passageway of the inlet plenum and the opening 24 may form part of the coolant passageway of the inlet plenum.

FIG. 1 also depicts openings 16, 22 and 26 that may be associated with the outlet plenum of the fuel cell stack. In this regard, the opening 16 may form part of the oxidant passageway of the outlet plenum, the opening 22 may form part of the fuel passageway of the outlet plenum and the opening 26 may form part of the coolant passageway of the outlet plenum.

Thus, for the exemplary cathode cooler flow plate 10 that is depicted in FIG. 1, oxidant flows from the opening 14 through the serpentine flow channels 12 and into the opening 16.

For purposes of isolating the fuel, oxidant and coolant flows from each other, the flow plate 10 includes grooves to receive elastomeric gaskets. For example, a gasket 100 may extend around the periphery of the opening 14, the active area 11 and the opening 16 for purposes of sealing off the oxidant flow from the other flows. The gasket 100 may also seal off and separate the fuel openings 20 and 22 from the oxidant and coolant openings. Furthermore, the flow plate 10 may include grooves for corresponding gaskets 30 and 40 that seal off the coolant openings 30 and 26.

Referring to FIG. 2, on its bottom side, the anode cooler flow plate 10 includes serpentine coolant flow channels 50 that extend between the coolant input 24 and output 40 openings. The coolant flow channels 50 align with coolant flow channels of an anode cooler flow plate (not shown) in the fuel cell stack.

Thus, as can be seen from FIGS. 1 and 2, the top surface of the cathode cooler flow plate 10 is associated with an oxidant flow and as such, the top surface of the flow plate 10 may be labeled the cathode side of the flow plate 10. The bottom surface of the plate 10 is associated with a coolant flow and thus, may be labeled the “coolant side” of the flow plate 10). Flow plates that have a reactant flow on one side and a coolant flow on the other are called “cooler” flow plates and are generally associated with a stack design in which the fuel cells are formed from two types of flow plates: an anode cooler flow plate, or a flow plate that has an anode side and a coolant side; and a cathode cooler flow plate (such as the flow plate 10), or a flow plate that has a cathode side and a coolant side.

A fuel cell stack may be assembled using an alternating order of cathode cooler and anode cooler flow plates. Every other flow plate pair (along with the gaskets and MEA) forms a fuel cell; and coolant channels are formed between the remaining flow plates.

Other stack designs are possible. For example, alternatively, the fuel cell stack may be formed from a repeating three flow plate design: an anode cooler plate, a cathode cooler and a bipolar plate, a plate that has an anode side and a cathode side.

FIG. 3 depicts an exemplary fuel cell stack 100 that may be formed with the two flow plate design. In other words, each fuel cell of the fuel cell stack 100 is formed from an anode cooler plate 108 and a cathode cooler plate 110. Thus, the upper surface oxidant flow channels of the cathode cooler plate 110 flow oxidant to the MEA, and the lower surface fuel channels of the adjacent anode cooler plate 108 flow fuel to the MEA. Each pair of anode cooler 108 and cathode cooler 110 plates, along with the MEA and gaskets, form a fuel cell unit 104 that repeats throughout the stack 100.

In accordance with embodiments of the invention that are described herein, the fuel cell stack includes features, such as MEA pockets, that limit the deflection or strain on the MEAs and hence, causes a stress relaxation rather than a creep to take place. This greatly reduces membrane thinning and puncture. Furthermore, the ability to precisely control the strain allows the stack to benefit from a phosphoric acid flow from the MEA to reduce the interfacial resistance of the MEA.

More specifically, the elastic properties of the electrode gas diffusion layer (GDL) substrates of the MEAs translate the constant strain into a force that is applied to the membrane, which declines with time. The stiffness characteristics of the electrode GDL and the depth of the MEA pocket control the initial and the final forces, respectively, and may be chosen such that the initial force is relatively low and declines to essentially zero while still maintaining an exemplary membrane thickness. The initial force hydraulically forces phosphoric acid from the membrane into the outer layers of the GDL, which is important because of the following. Low compression forces on the stack generally result in exponentially increasing interfacial contact resistance and essentially a lower limit on acceptable compression forces. Yet, it has been discovered that small size, high temperature PBI-H₃PO₄ fuel cells have operated successively for well over 10,000 hours. These cells are essentially strain limited by the use of large area Teflon® gaskets, which results in the same boundary conditions that are imposed by the recess and hence, a compression load, which declines to near zero over the course of time. Such cells run successively with no sign of excessive interfacial contact resistance. It has been discovered that at very low loads (a load less than 5 pounds per square inch, for example) the presence of phosphoric acid has the effect of lowering the contact resistance. The mechanism may be due to preventing the buildup of non-conducting oxide layers on the carbon fibers of the GDL and/or the surface of the plate.

FIGS. 4, 5, 6, 7 and 8 depict various examples of ways to form an MEA pocket between two adjacent flow plates. Turning now to the specific details, FIG. 4 depicts an exemplary stack section 150, which illustrates a pocket formed for a MEA 151 in accordance with an embodiment of the invention. The MEA pocket is formed from adjacent anode 152 and cathode 170 cooler flow plates. The anode cooler flow plate 152 includes a lower surface active area 154, which communicates a fuel flow to the MEA 151. The cathode cooler flow plate 170 includes an upper 171 active area to communicate an oxidant flow to the MEA 151.

The active area 154 of the anode cooler flow plate 152 is recessed with respect to a hard stop surface 155 of the anode cooler plate 152. In this regard, the hard stop surface 155 is formed on the lower surface of the anode cooler flow plate 152 and is part of a hard stop region 174 that is located outside the sealed reactant region of the fuel cell (i.e., located outside of gaskets 180 and 190). When the stack that contains the anode 152 and cathode 170 cooler flow plates is compressed, the hard stop surfaces 155 and 171 come into proximity with each other, only separated by a Kapton layer 178 of the MEA 154 and an electrically insulative layer 176. As depicted in FIG. 4, the hard stop surfaces 155 and 171 are farther apart than the surfaces 154 and 171, thereby creating a pocket for the MEA 151.

Thus, the surface 154 is recessed by a depth 160 relative to the hard stop surface 155 to create a pocket for the MEA 151.

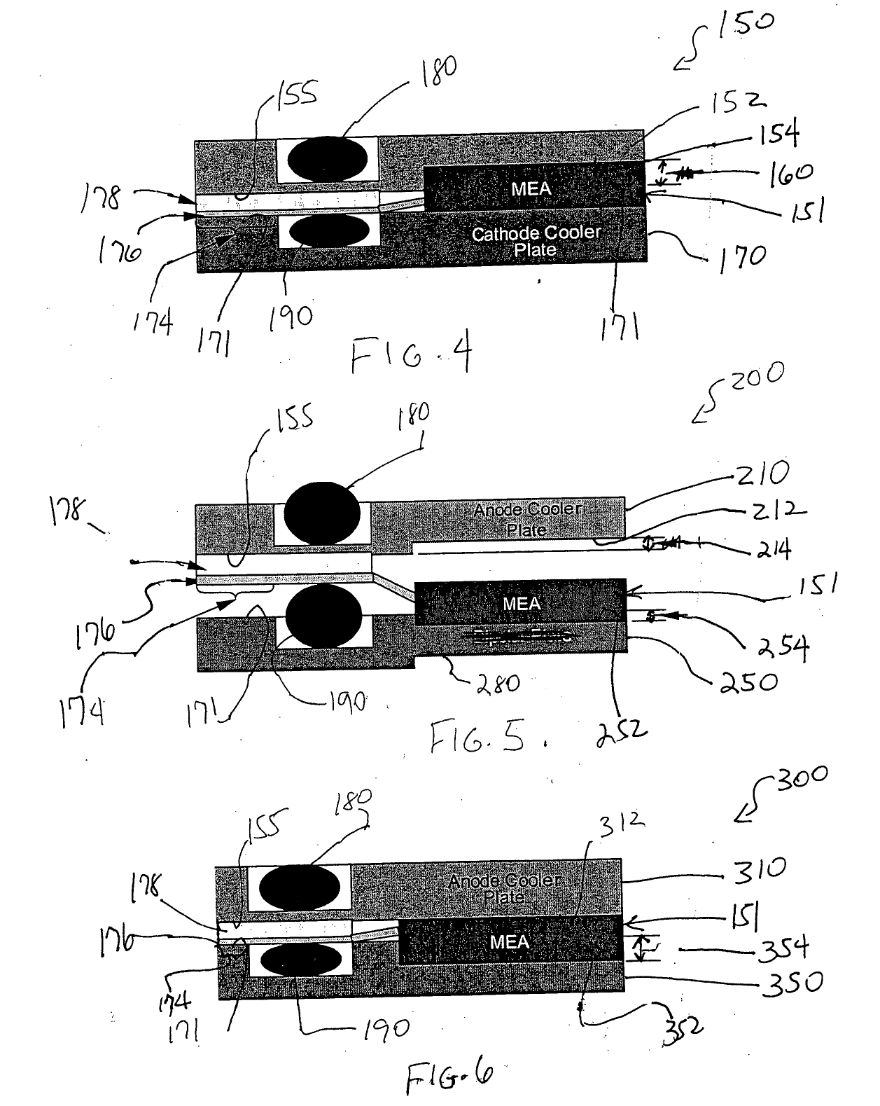

FIG. 5 depicts another variation in which an exemplary stack section 200 forms a pocket for the MEA 151 for the case where three flow plates are used to form each fuel cell (i.e., each fuel cell is formed from an anode cooler flow plate, a bipolar flow plate and a cathode cooler flow plate). The stack section 200 is depicted as an exploded view in FIG. 5. Like reference numerals are used to depict similar elements to those shown in FIG. 4. The stack section 200 includes an anode cooler flow plate 210 and a bipolar flow plate 250. The anode cooler flow plate 210 has a active region 212 that communicates a fuel flow to the MEA 151, and the upper surface of the bipolar flow plate 250 includes an active region 252 to communicate an oxidant flow to the MEA 151. Unlike the arrangement that is depicted in FIG. 4, the anode 212 and cathode 252 active regions of the adjacent flow plates are both recessed to form a pocket for the MEA 151. Thus, the active region 212 of the anode cooler plate 210 is recessed by a depth 214 with respect to the hard stop surface 155 of the anode cooler plate 210. Likewise, the hard stop surface 252 of the bipolar plate 250 is recessed by a depth 254 relative to the hard stop surface 171. Therefore, the combined depths 214 and 254 form the effective depth of the pocket to receive the MEA 151.

As can be seen from FIG. 5, the bottom surface of the bipolar plate 250 includes an active region 280 for purposes of flowing fuel to an MEA (not depicted in FIG. 5) that resides next to the bipolar plate 250. The active region 280 of the bipolar plate 250 forms part of the pocket for this MEA, and the cathode cooler plate (not depicted in FIG. 5) that is located below this MEA forms the remaining depth of the pocket.

FIG. 6 depicts another exemplary fuel cell stack section 300, which includes a cathode cooler flow plate 350 and an anode cooler flow plate 310 of a fuel cell. Like reference numerals are used to depict similar elements. An MEA pocket is formed from a recessed region in the cathode cooler flow plate 350 in a flow plate portion 300. In the flow plate portion 300, the anode cooler flow plate 310 (unlike the anode cooler plate 152) includes an active region 312 that is generally planar with the hard stop surface 155. The active region 352 of the cathode cooler plate 350, however, is recessed by a depth 354 with respect to the hard stop surface 171 to form the MEA pocket. Thus, the depth 354 is sufficient to accommodate the thickness of the MEA 151 that is disposed therein.

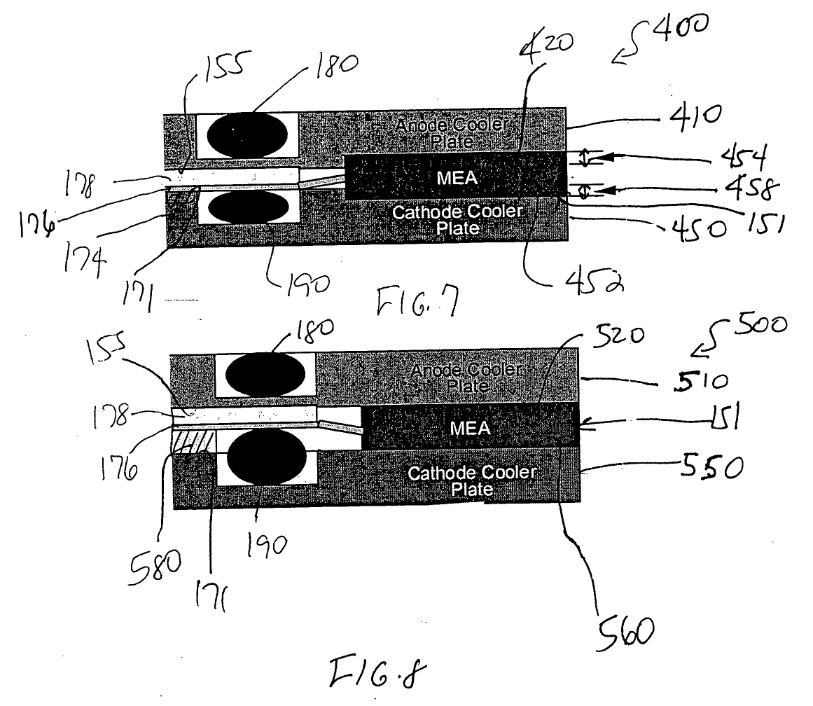

FIG. 7 depicts another exemplary fuel cell stack section 400, illustrating an MEA pocket that is formed from a two flow plate fuel cell design that includes anode cooler 410 and cathode cooler 450 flow plates. Similar reference numerals are used to depict similar elements.

The bottom surface of the anode cooler flow plate 410 includes an active region 420 that is recessed by a depth 454 with respect to the hard stop surface 155. Likewise, the upper surface of the cathode cooler flow plate 450 includes an active area 452 that is recessed by a depth 458 with respect to the hard stop surface 171. Therefore, the effective depth of the MEA pocket is formed from the combined depths 454 and 458.

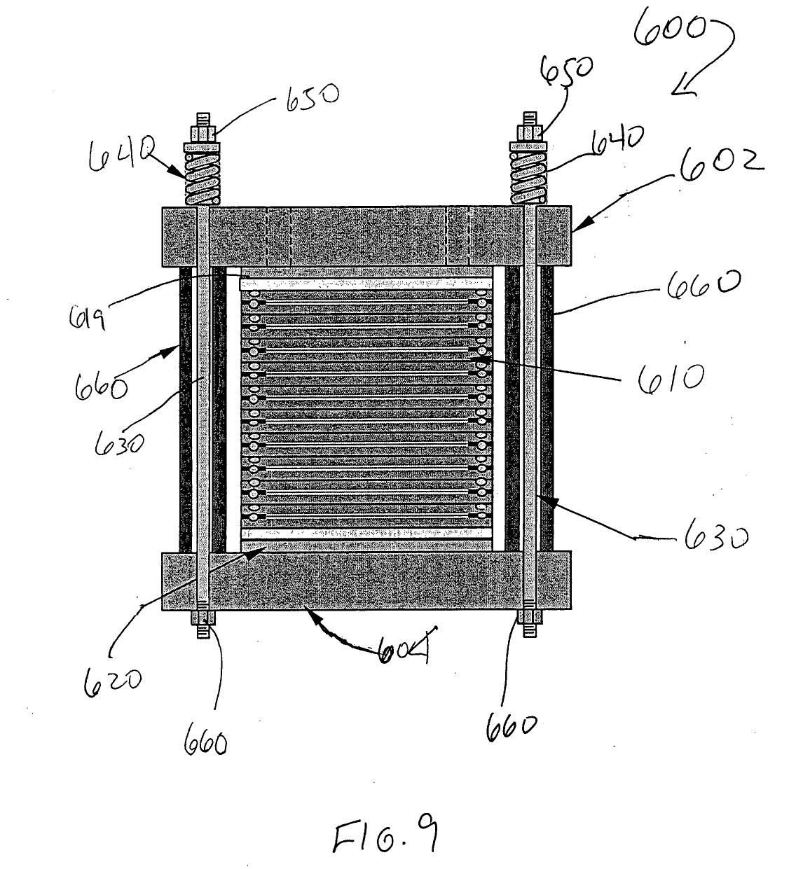

FIG. 8 depicts yet another exemplary fuel cell stack section 500 that forms an MEA pocket. However, here, a shim 580 in the hard stop region 174 is used to form the MEA pocket. In other words, the pocket is formed from the thickness of the shim 580, instead of from a recessed region in one or both of the adjacent flow plates. The fuel cell stack section 500 includes an anode cooler flow plate 510, which includes a lower surface that has an active area 520 that is not recessed with respect to the hard stop surface 155. Likewise, the stack portion 500 includes a cathode cooler flow plate 550 that has an upper surface, which includes an active area 560 that is not recessed with respect to the hard stop surface 171. As an example, the shim 580 may be constructed of a hard material, such as a Teflon® sheet, as an example. Other materials may be used for the shim 580, in accordance with other embodiments of the invention.

Features other than pockets may be used to regulate the compressive force that is exerted on the MEAs in accordance with other embodiments of the invention. For example, the compression of the MEAs may be limited using a stop member that is positioned between the end plates of a fuel cell stack to receive excessive force that would otherwise be applied to the MEAS. More specifically, FIG. 9 depicts an exemplary embodiment of a fuel cell stack 600, which includes such a stop member.

The fuel cell stack 600 includes flow plates 610, MEAs and gaskets that form fuel cells. The flow plates 610 are located between upper 602 and lower 604 end plates. It is noted that insulative plates 619 and 620 may be located between the flow plates 610 and the upper 602 and lower 604 end plates, respectively.

The end plates 602 and 604 hold the flow plates 610 in compression due to an arrangement consisting of tie rods 630 and springs 640. The tie rods 630 extend through the end plates 602 and 604; and as depicted in FIG. 9, for each tie rod 630, a corresponding spring 640 resides between an upper end 650 of the tie rods 630 and the upper surface of the end plate 602. A lower end 660 of the tie rod 630 is effectively fixed to the bottom surface of the end plate 604 via a thread and nut connection.

For purposes of limiting the compressive force on the flow plates 610 (and thus, limiting the compressive force on the MEAs contained within the flow plates 610), the fuel cell stack 600 includes metal tubes 660, each of which surrounds an associated tie rod 630. Thus, as shown in FIG. 9, each tie rod 630 extends through the central passageway of one of the metal tubes 660; and the metal tube 660 resides between the lower surface of the upper end plate 602 and the upper surface of the lower end plate 604. Therefore, metal tubes 660 form a stop for limiting the compression that is applied on the flow plate 610 by the end plates 602 and 604, as any excessive force is transferred to the metal tubes 660.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A flow plate for a fuel cell, comprising:
an active area to communicate a reactant flow to a membrane electrode assembly of the fuel cell; and
a recessed region substantially the size as the active area to receive the membrane electrode assembly.

2. The flow plate of claim 1, further comprising:
a second non-recessed region outside of the active area to absorb a compressive force exerted on the flow plate.

3. The flow plate of claim 2, wherein the second region and recessed region are adapted to limit a compressive force exerted on the membrane electrode assembly by compression of a stack that contains the flow plate.

4. The flow plate of claim 1, wherein the active area comprises flow channels.

5. The flow plate of claim 4, wherein the flow channels comprise serpentine flow channels.

6. The flow plate of claim 1, wherein the recessed region cooperates with a recessed region of an opposing flow plate to form a pocket to receive the membrane electrode assembly.

7. The flow plate of claim 1, wherein the flow plate comprises reactant flows channels on opposite faces of the flow plate.

8. A fuel cell stack, comprising:
a first flow plate;
a second flow plate;
a membrane electrode assembly;
an active region located between the first and second flow plates to communicate reactant flows to a fuel cell; and
a pocket formed in the active region to receive the membrane electrode assembly.

9. The fuel cell stack of claim 8, wherein a pocket is formed between a non-recessed region of the first flow plate and a recessed region of the second flow plate.

10. The fuel cell stack of claim 8, wherein the second flow plate comprises anode flow channels in the active region.

11. The fuel cell stack of claim 9, wherein the second flow plate comprises cathode flow channels in the active region.

12. The fuel cell stack of claim 9, wherein the second flow plate comprise one of anode flow channels and cathode flow channels in the active region and the other of said anode flow channels and cathode flow channels on a side of the second flow plate opposite from a side of the second flow plate which faces the first flow plate.

13. The fuel cell stack of claim 8, wherein the pocket is formed from recessed regions in the first and second flow plates.

14. The fuel cell stack of claim 8, further comprising:
a shim located between the first and second flow plates to form the pocket.

15. A fuel cell stack, comprising:
end plates;
flow plates located between the end plates; and
a stop located between the end plates to limit a compressive force exerted on the flow plates.

16. The fuel cell stack of claim 15, further comprising:
tie rods adapted to extend through the end plates and exert the compressive force on the flow plates.

17. The fuel cell stack of claim 16, wherein the stop comprises at least one tube adapted to surround at least one of the tie rods.

18. The fuel cell stack of claim 17, wherein said at least one tube is located between the end plates.

19. The fuel cell stack of claim 17, wherein said at least one tube comprises at least one metal tube.

20. A method usable with a fuel cell stack, comprising:
forming an active region between first and second flow plates of the fuel cell stack to communicate reactant flows to a fuel cell; and
forming a pocket in the active region to receive a membrane electrode assembly of the fuel cell.

21. The method of claim 20, wherein the act of forming comprises forming the pocket between a non-recessed region of the first flow plate and a recessed region of the second flow plate.

22. The method of claim 21, further comprising:
forming anode flow channels in a second flow plate in the active region.

23. The method of claim 21, further comprising:
forming cathode flow channels in a second flow plate the active region.

24. The method of claim 21, further comprising:
forming one of anode flow channels and cathode flow channels in the second plate active region and forming the other of said anode flow channels and cathode flow channels on a side of the second flow plate opposite from a side of the second flow plate which faces the first flow plate.

25. The method of claim 20, wherein the act of forming the pocket comprises forming recessed regions in the first and second flow plates.

26. The method of claim 20, wherein the act of forming the pocket comprises providing a shim between the first and second flow plates.
